(19) United States
(12) Patent Application Publication
(10) Pub. No.: US 2006/0152777 A1
(43) Pub. Date: Jul. 13, 2006

(54) Image processing method and apparatus capable of effectively reading an image using a light diffuser

(76) Inventor: Takeshi Iwasaki, Yashio-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/293,377

(22) Filed: Dec. 5, 2005

(30) Foreign Application Priority Data
Dec. 6, 2004 (JP) 2004-352559
Nov. 10, 2005 (JP) 2005-325608

(51) Int. Cl. H04N 1/46

(52) U.S. Cl. 358/509

(57) ABSTRACT

An image processing method and apparatus includes an image reading mechanism having a light source, a light guiding device, a light diffusing member. The light guiding device has a light emitting surface and guides light generated by the light source and allows the light to come out through the light emitting surface towards a document. The light diffusing member covers the light emitting surface of the light guiding device and diffuses the light coming out through the light emitting surface towards the document.

### BACKGROUND

1. Field

This patent specification describes a method and apparatus for image processing, and more particularly a method and apparatus for image processing capable of effectively reading an image without causing an undesired uneven reading by using a light diffuser.

2. Discussion of the Background

A background image processing apparatus, such as an image scanner, a digital copying machine, a facsimile machine, and so on, generally includes an image reading unit that makes a document be held or move on a contact glass. To read the image, the image reading unit generates light rays, has the document exposed to the light rays through the contact glass, and brings the light rays reflected by the document into focus on an image sensor. In this reading process, however, the document is not necessarily in close and even contact with the contact glass. A phenomenon that the document has a portion not in close contact with the contact glass is referred to as a floating. The floating causes a change of illuminance on the document surface which results in an undesired uneven image reading.

Referring to FIG. 1, a typical structure of the image reading unit and its associated mechanisms in the background image processing apparatus is explained. As illustrated in FIG. 1, in an image sensor unit 70 is arranged under a contact glass 79. A document 75 is transferred in a direction indicated by an arrow F by transfer roller pairs 71 and 72 and is read by the image sensor unit 70. The image sensor unit 70 generally includes a light source 60, a lens array 76, a photoelectric transducer 77, and a frame. The light source irradiates light to the document 75. The lens array 76 gathers the light reflected from the document 75 into focus on the photoelectric transducer 77 that generates an electrical output in response to an amount of the light received. The frame 78 supports these components. In this structure, the image sensor unit 70 is disposed at as a close position as possible to the contact lens 79 and the document 75 in order to meet the requirements of downsizing the whole apparatus and increasing an efficiency of lighting the document surface using the light source 60.

FIG. 2 illustrates an exemplary structure of another image sensor unit which attempts to solve a problem of the floating. In FIG. 2, the image sensor unit is arranged under a contact lens 89 and includes two lighting devices 84, a lens array 86, a photoelectric transducer 87, and a frame 88. Each of the two lighting devices 84 includes a light source 82 and a light guiding device 83. The two lighting devices 84 are symmetrically disposed with respect to the lens array 86 at such positions as to provide respective peak amounts of light at different positions in height from the contact glass 89.

FIG. 3 illustrates an exemplary cross-sectional structure of a lighting device that irradiates a document with light on a contact glass. The lighting device of FIG. 3 includes a tubular lamp 91 internally having a filament, a light beam reflector 97, and a beam shaping diffuser 98. The tubular lamp 91 is arranged in parallel to a length of a document 90 having a width W. The light beam reflector 97 has a cross section of a curved line and is extended along a whole length of the tubular lamp 91 so as to reflect the light from the tubular lamp 91 towards the document 90. The beam shaping diffuser 98 receives and diffuses the light reflected by the light beam reflector 97 before the light reaches the document 90.

### SUMMARY

This patent specification describes a novel image lighting apparatus which generates light in a strip form having a width covering a width of a document to be read by an image reading apparatus. In one example, a novel image lighting apparatus includes a light source, a light guiding device, a light diffusing member. The light source generates light. The light guiding device has a light emitting surface and is configured to guide the light generated by the light source and to allow the light to come out through the light emitting surface towards a document to be read. The light diffusing member is configured to cover the light emitting surface of the light guiding device and to diffuse the light coming out through the light emitting surface towards the document.

This patent specification further describes a novel image sensor apparatus which generates light in a strip form having a width covering a width of a document and reads the document with an image sensor. In one example, a novel image sensor apparatus includes a lighting unit, an image sensor, an image focusing member, and a frame. The lighting unit includes a light source, a light guiding device, and a light diffusing member. The light source generates light. The light guiding device has a light emitting surface and is configured to guide the light generated by the light source and to allow the light to come out through the light emitting surface towards a document to be read. The light diffusing member is configured to cover the light emitting surface of the light guiding device and to diffuse the light coming out through the light emitting surface towards the document. The image sensor is configured to generate an electrical output in response to an amount of incident light received. The image focusing member is configured to receive and gather the light reflected from the document. The frame is configured to support and form the lighting unit, the image sensor, and the image focusing member into a single construction.

This patent specification further describes an image reading apparatus which uses the above-described image sensor unit. In one example, a novel image reading apparatus includes a contact glass and an image sensor. The contact glass is configured to form a place on which a document to be read is placed. The an image sensor is disposed opposite to the document to be read relative to the contact glass and is configured to read image information of the document. The image sensor includes a light source, a light guiding device, and a light diffusing member. The light source generates light. The light guiding device has a light emitting surface and is configured to guide the light generated by the light source and to allow the light to come out through the light emitting surface towards a document to be read. The light diffusing member is configured to cover the light emitting surface of the light guiding device and to diffuse the light coming out through the light emitting surface towards the document.

This patent specification further describes an image forming apparatus which uses the above-described image sensor unit. In one example, a novel image forming apparatus includes a contact glass, an image sensor, and an image forming mechanism. The contact glass is configured to form a place on which a document to be read is placed. The image sensor is disposed opposite to the document to be read relative to the contact glass and is configured to read image information of the document. The image sensor includes a light source, a light guiding device, and a light diffusing member. The light source generates light. The light guiding device has a light emitting surface and is configured to guide the light generated by the light source and to allow the light to come out through the light emitting surface towards a document to be read. The light diffusing member is configured to cover the light emitting surface of the light guiding device and to diffuse the light coming out through the light emitting surface towards the document. The image forming mechanism is configured to form an image in accordance with the image information of the document read by the image sensor.

This patent specification further describes an image lighting method which generates light in a strip form having a width covering a width of a document to be read by an image reading apparatus. In one example, a novel lighting method includes the steps of generating, deforming, guiding, and adjusting. The generating step generates light. The deforming step deforms the light from the generating means into a strip form having a width covering a width of a document to be read. The guiding step guides the light towards the document to be read. The adjusting step adjusts an amount of the light in the strip form before reaching the document.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a background image reading apparatus installed in an image forming apparatus;

FIG. 2 is a schematic diagram of a background image sensor unit;

FIG. 3 is a schematic diagram of a background lighting apparatus;

FIG. 4 is a schematic diagram of a lighting device according to an example embodiment;

FIG. 5 is a schematically exploded diagram of the lighting device of FIG. 4;

FIG. 6 is a schematic illustration of a light diffusion pattern used in the lighting device of FIG. 4;

FIG. 7 is a cross-sectional view of an image sensor unit having the light device of FIG. 4 in a copying machine;

FIG. 8 is a schematic diagram of a digital copying machine using the image sensor unit of FIG. 7; and

FIG. 9 is a graph for explaining a favorable effect of using a light diffusion member in the lighting device of FIG. 4.

### DETAILED DESCRIPTION OF PREFERRED EMBODIMENTS

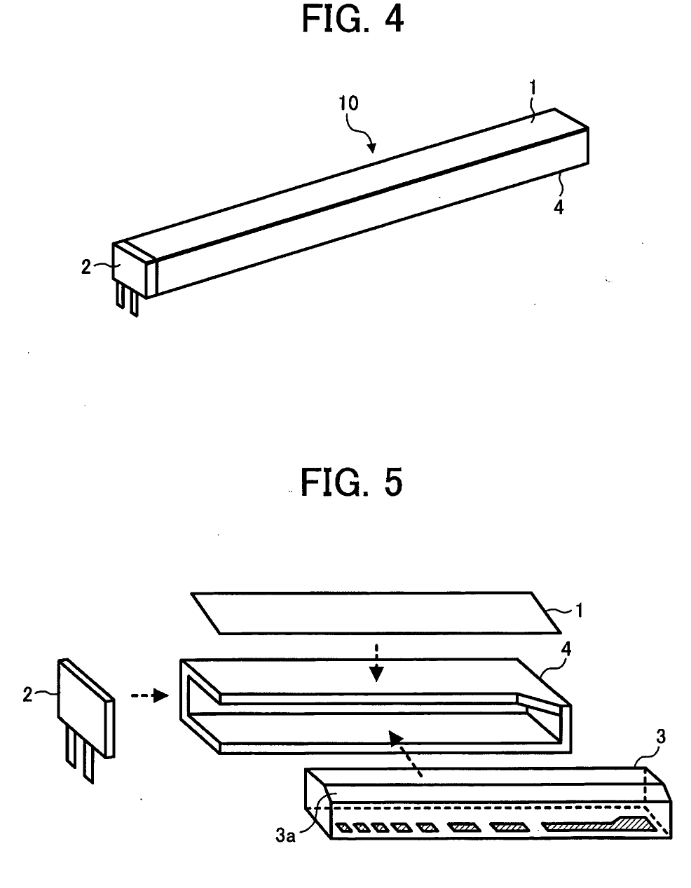

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIGS. 4-6, a lighting device 10 according to an example embodiment is explained. The lighting device 10 of FIG. 4 has a bar-like shape as a whole and is provided in use for an image forming apparatus to perform a function to irradiate a document with scanning light. As illustrated in FIGS. 4 and 5, the lighting device 10 includes a sheet member 1, a light source 2, a light guiding member 3, and an enclosing member 4. The light source 2 includes a lighting member such as an LED (light-emitting diode), for example, for generating light to which the document is exposed. As an alternative, a tubular lamp may be used as a light source. The light source 2 is disposed at an open longitudinal end of the enclosing member 4. The light guiding member 3 has a bar-like structure such as a quadrangular prism, for example, and includes transparent materials such as an acryl resin, an optical glass, or the like. The light guiding member 3 has a light emitting surface 3a which has a rectangular shape extended along an entire length between two opposite longitudinal ends thereof, as illustrated in FIG. 5. The light guiding member 3 receives the light emitted by the light source 2, guides the light therethrough, and allows the light to exit outside through the light emitting surface 3a towards a document (not shown) to be read.

The enclosing member 4 has a box-like structure to enclose the light guiding member 3. The enclosing member 4 has an open longitudinal end which is sealed by mounting the light source 2 thereto and an open side end through which the light guiding member 3 is inserted. With the light guiding member 3 completely inserted inside the enclosing member 4, the enclosing member 4 forms a rectangular window at a position facing an entire portion of the light emitting surface 3a. The enclosing member 4 also serves as a dust protector for protecting the light guiding member 3 from dust as well as from flaws. The enclosing member 4 generally includes a resin of white to have a relatively high reflectivity. The enclosing member 4 has inside surfaces facing outside surfaces of the light guiding member 4, except for the light emitting surface 3a.

The light emitted by the light source is transmitted through inside the light guiding member 3 with repetitive impinging and reflection against the inside surfaces of the enclosing member 4. Thus, the light is guided to the opposite longitudinal end of the light guiding member 3, and is further transmitted outside through the light emitting surface 3a of the light guiding member 3.

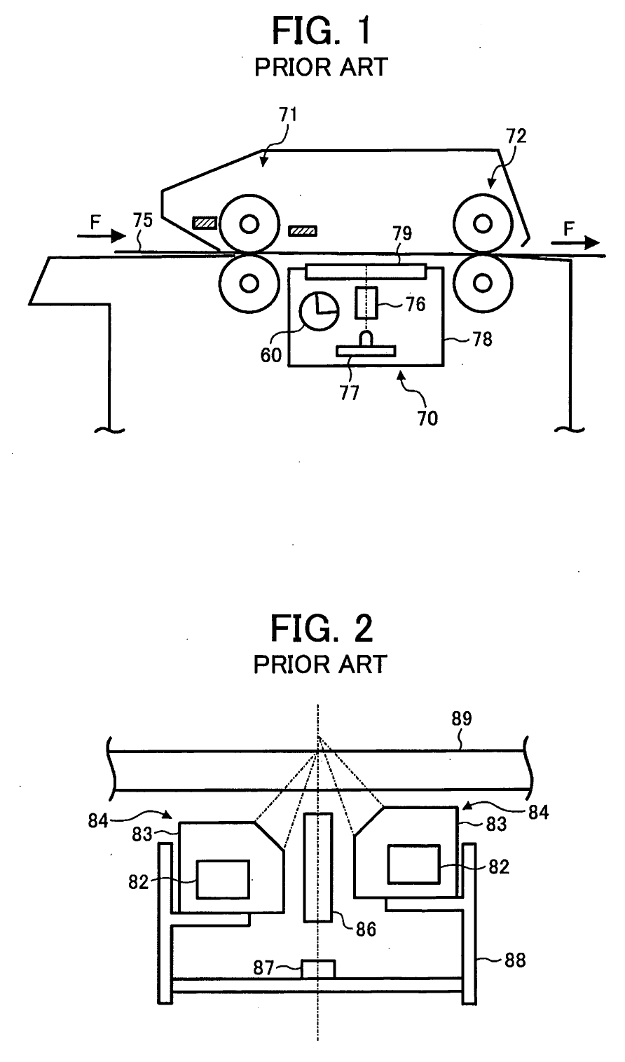

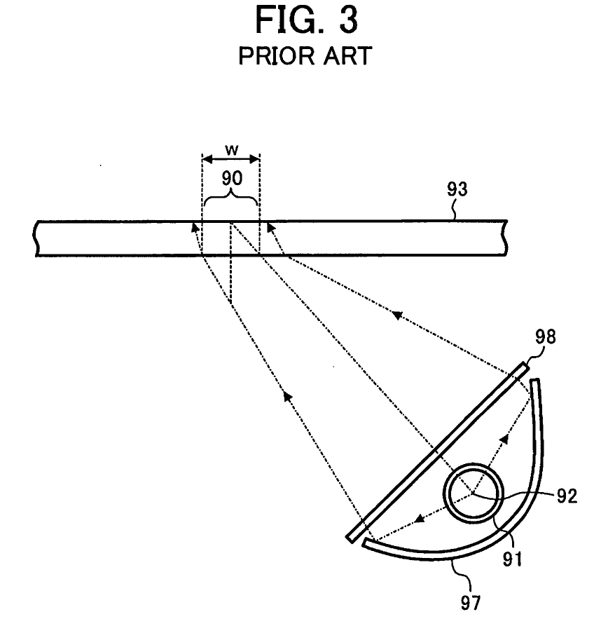

The sheet member 1 is fixed to an upper surface of the enclosing member 4 with an adhesive tape or the like so as to cover the rectangular window of the enclosing member 4, as illustrated in FIG. 1. The sheet member 1 includes a material of polymethyl methacrylate or polystyrene and is configured to have a relatively high light transmittance with a relatively high haze so as to evenly diffuse incident light.

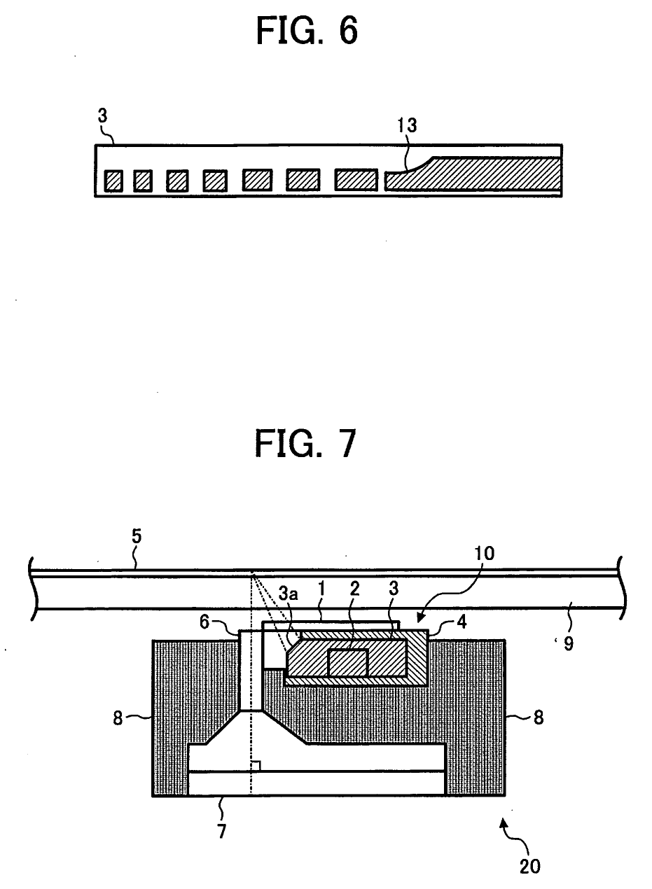

As illustrated in FIG. 6, the light guiding member 3 has a bottom surface on which a light diffusion pattern 13, shown as a plurality of areas indicated with a hatch pattern, is pained in white. The plurality of such white areas of the light diffusion pattern 13 are arranged in series in a longitudinal direction of the light guiding member 3 such that the white area gradually increases with an increase of a distance of the white area from the longitudinal end of the light guiding member 3 on which the light source 2 is mounted.

With the above-described light diffusion pattern 13, the light emitted from the light source 2 is entered into the light guiding member 3, transmitted through the light guiding member 3, diffused and reflected by the plurality of white areas of the light diffusion pattern 13, and exits from the light emitting surface 3a towards the document to be read.

The purpose of the gradually increasing white areas of the light diffusion patter 13 is to substantially equalizing a light amount coming out towards the document through the light emitting surface 3a in the longitudinal direction of the light guiding member 3. The paint of the white areas includes a material such as MgO, TiO₂, SiO₂, or the like.

Referring to FIG. 7, an image sensor unit 20 including the lighting device 10 of FIG. 4 is explained. The image sensor unit 20 of FIG. 7 is widely used in an image reading device of various image processing apparatuses such as an image scanner, a digital copying machine, a facsimile machine, and so on. As illustrated in FIG. 7, the image sensor unit 20 is usually disposed under a contact glass 9 which is a part of an image processing apparatus such a digital copying machine and on which a document to be read by the image reading device.

As illustrated in FIG. 7, the image sensor unit 20 includes a lens array 6, a photoelectric transducer 7, and a frame 8, in addition to the lighting device 10. The lens array 6 forms an image and may include a Cellhock lens array (trade name) (made by Nippon Sheet Glass Co., Ltd.). The photoelectric transducer 7 is used as an image sensor. The frame 8 supports thereon all together the lens array 6, the photoelectric transducer 7, and the lighting device 10. As illustrated in FIG. 7, an edge of the sheet member 1 of the lighting device 10 is in contact with the lens array 6 so that the position of the sheet member 1 is determined. The lens array 6 receives the light which is emitted from the light guiding member 3 of the lighting device 10 through the light emitting surface 3a and is reflected by a front surface of a document 5 placed on the contact glass, and causes the light to intensively impinge onto the photoelectric transducer 7, thereby forming an image on the photoelectric transducer 7. The photoelectric transducer 7 generates an electric output in response to an incident light amount received.

As an alternative to the photoelectric transducer 7, a CCD (charge-coupled device) can be used as an image sensor.

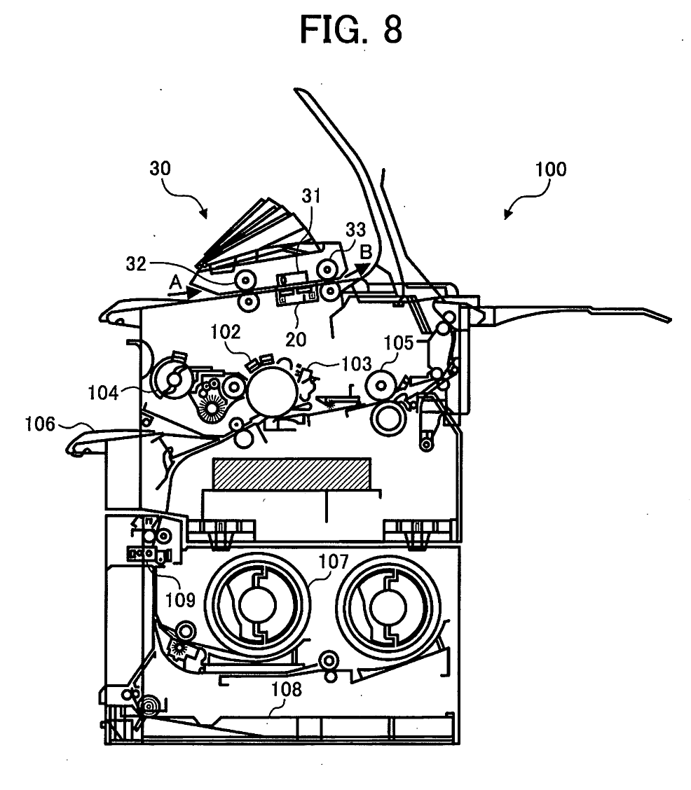

Referring to FIG. 8, a digital copying machine 100 as one example of an image processing apparatus according to an example embodiment is explained. The digital copying machine 100 of FIG. 8 is an electrophotographic image forming system but may be, as an alternative, an inkjet-method image forming system. As illustrated in FIG. 8, the digital copying machine 100 includes an image reading unit 30, an image writing unit 102, an image forming unit 103, an image development unit 104, an image fixing unit 105, a manual insertion unit 106, a roll-sheet supply unit 107, a cut-sheet supply unit 108, and a roll-sheet cutting unit 109.

The image reading unit 30 includes the image sensor unit 20, an image reading device 31, and sheet transmission roller pairs 32 and 33. The image reading unit 30 is configured to transfer the document 5 which is entered in a direction indicated by an arrow A, to read the document 5, and to eject the document in a direction indicated by an arrow B. The image writing unit 102 generates image writing light rays in accordance with an image signal generated by the image reading unit 30 by reading the document 5. The image forming unit 103 forms an electrostatic latent image on an image carrying member with the image writing light rays generated by the image writing unit 102. The image development unit 104 develops the electrostatic latent image formed on the image carrying member into a visual image with toner. The image fixing unit 105 fixes the toner forming the visual image on a recording sheet. The manual sheet insertion unit 104 allows a manual insertion for manually inserting a recording sheet. The roll-sheet supply unit 107 stores a recording sheet in a wide continuous and rolled form, and supplies it as an alternative to the cut sheet. The cut-sheet supply unit 108 stores a plurality of recording sheets in a cut-sheet form, such as an A3-sized form, for example. The rolled-sheet cutting unit 109 is configured to cut the rolled sheet in accordance with a requisite form size.

In the digital copying machine 100 of FIG. 5, the sheet transmission roller pairs 32 and 33 transfer the document 5 in the direction indicated by the arrow A so that the image sensor unit 20 reads image information contained in a surface of the document 5. In this process, the light source 2 emits light towards the light guiding member 3, and the light is then entered the light guiding member 3, and is transmitted in the light guiding member 3 with being reflected by surfaces of the light guiding member 3 and the reflection surfaces of the enclosing member 4. More specifically, the light being transmitted in the light guiding member 3 is reflected by the light diffusion surface 13 provided at the bottom surface of the light guiding member 3 towards the light emitting surface 3a and is ejected from the light guiding member 3 through the light emitting surface 3a in a direction towards the front surface of the document 5. Then, the light is diffused outside through the sheet member 1 and impinges on the front surface of the document 5. Then, the light is reflected by the document 5 and is entered into the lens array 6 through which the light is caused to focus into an image on the photoelectric transducer 7. Thereby, the image information of the document 5 is read.

It should be noticed that there are several factors that affect reading accuracy in the above-described document reading operation. One factor is that the surface of the document 5 to be read has a roughness of minute bumps and dips. Another factor is a reading passage of the document 5 which is provided with a requisite minimum degree of transportation space for smooth document transportation and which therefore may cause variations of a surface position of the document 5 relative to the image sensor unit 20. There is still another factor that is illuminance on the surface of the document 5 provided by the lighting device 10. The illuminance on the surface of the document 5 is inversely proportional to the second power of a distance between the document surface and the lighting device 10. This leads to the fact that the document reading accuracy is affected more unfavorably when the distance between the lighting device 10 and the document 5 is narrower if the surface position of the document 5 is variable in the reading passage.

Assuming, for example, that the surface position of the document 5 is changed by 0.1 mm in each case of a 4-mm-distance and a 7-mm-distance between the lighting device 10 and the surface of the document 5. An illuminance variation on the surface of the document 5 is approximately 5% in the case of the 4-mm-distance and approximately 3% in the case of the 7-mm-distance. The calculations are {1−(4²/4.1²)}×100 for the 4-mm-distance and {1−(7²/7.1²)}×100 for the 7-mm-distance between the lighting device 10 and the surface of the document 5. As such, the illuminance variation is increased with a decrease of the distance between the lighting device 10 and the surface of the document 5. In other words, an adverse influence by the variation of the surface position of the document 5 to the reading accuracy is increased with a decrease of the distance between the lighting device 10 and the surface of the document 5.

In general, the lighting device 10 is arranged and configured to provide a maximum light amount to the surface of the document 5 when the surface of the document 5 is flat without a bending. Therefore, if the illuminance variation on the surface of the document 5 is increased relative to the variation of the surface position of the document 5, an image read by the image sensor unit 20 may include an undesired image unevenness. It takes place as an undesired image drop or emergence, particularly when an image having a density close to that of background is read. This is because a background density is normally set to a value below a readable threshold value so as not be read.

As described above, in the structure of this example, the light coming out from the light guiding member 3 through the light emitting surface 3a is diffused through the sheet member 1 and then impinges on the document 5. Accordingly, in this example, the luminous flux in a unit area on the surface of the document 5 is decreased, resulting in a moderation of a focusing property of the light exiting from the light guiding member 3. As a consequence, it brings an effect substantially similar to that obtained by moving the image sensor unit 20 away from the document surface. In other words, the illuminance variation is reduced on the document surface caused due to the variation of the surface position of the document.

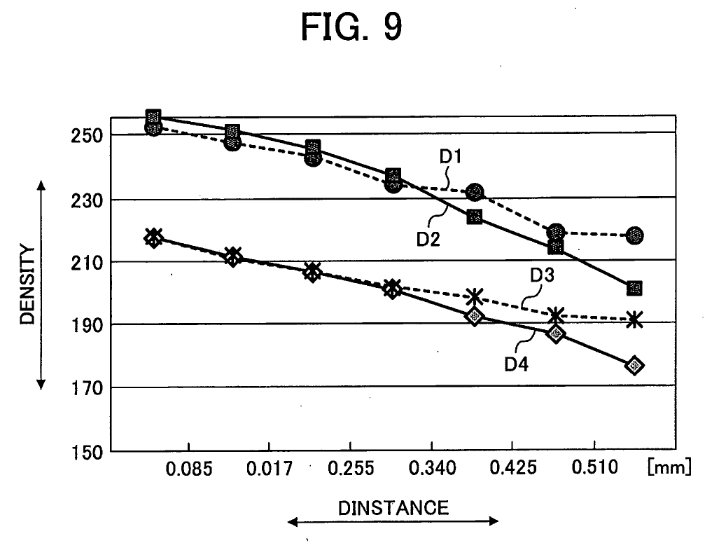

Referring to FIG. 9, experimental results of a light diffusion effect by the sheet member 1 are explained. This experiment was conducted by reading a test chart with the digital copying machine 100 equipped with the image sensor unit 20. In the experiment, the height of the surface of the test chart from the contact glass 9 was changed stepwise from 0 to 0.51 mm. The illumination intensity on the surface of the document was substituted by reading values in 256 grayscales obtained by the reading of the background and character portions having a density identification value of 0.2 in the test chart. As the sheet member 1, a translucent white sheet having a thickness of 0.1 mm was used. An LED (light-emitting diode) was used as the light source. The current value supplied to the LED was adjusted such that a value of an image reading level with use of the translucent white sheet was in substantial agreement with a value of an image reading level without use of the translucent white sheet, at a document height of 0.255 mm.

In the graph of FIG. 9, D1 is a case of reading the background with use of the translucent white sheet and D2 is a case of reading the background without the use of the translucent white sheet. Also, D3 is a case of reading a 0.2-density image with the use of the translucent white sheet and D4 is a case of reading the 0.2-density image without the use of the translucent white sheet.

As demonstrated in the graph of FIG. 9, changes of the reading level due to the change of the document surface by 0.51 mm with the use of the translucent white sheet are 34.8 digits by the reading of the background and 24.4 digits by the reading of a 0.2-density image. The calculations are 252.0−217.2=34.8 and 216.3−191.9=24.4.

Also, changes of the reading level due to the change of the document surface by 0.51 mm without the use of the translucent white sheet are 52.9 digits by the reading of the background and 40.8 digits by the reading of a 0.2-density image. The respective calculations are 253.8−200.9=52.9 and 217.2−176.4=40.8.

Accordingly, an effect on a reduction of the reading level by the use of the translucent white sheet is approximately 34% in the case of reading the background and approximately 40% in the case of reading the 0.2-density image. The respective calculations are (1−34.8/52.9)×100≅34 and (1−24.4/40.8)×100≅40.

Thus, diffusing the light emitted from the light emitting surface 3a with the sheet member 1 generates an effect of the reading level reduction in a substantial agreement with an effect obtained by a movement of the image sensor unit 20 away from the document 5. As a result, this structure improves the undesired unevenness of density caused due to bending of the document 5.

Numerous additional modifications and variations are possible in light of the above teachings. It is therefore to be understood that within the scope of the appended claims, the disclosure of this patent specification may be practiced otherwise than as specifically described herein.

This patent specification is based on Japanese patent applications, No. JP2004-352559 filed on Dec. 6, 2004 and No. JP2005-325608 filed on Nov. 10, 2005, in the Japan Patent Office, the entire contents of each of which are incorporated by reference herein.

What is claimed is:

1. An image lighting apparatus, comprising:
a light source generating light;
a light guiding device having a light emitting surface and configured to guide the light generated by the light source and to allow the light to come out through the light emitting surface towards a document to be read; and
a light diffusing member configured to cover the light emitting surface of the light guiding device and to diffuse the light coming out through the light emitting surface towards the document.

2. The image lighting apparatus of claim 1, wherein the light source includes an LED fixed to one longitudinal end of the light guiding device, the light diffusing member includes an optical diffusing sheet having a light transmittance property and covering the light emitting surface, and the light guiding device includes a bar-like-shaped member of a transparent resin material along which length the light emitting surface is extended.

3. The image lighting apparatus of claim 1, further comprising:
an enclosing member configured to enclose the light guiding device and having light-reflecting inside-surfaces facing outside surfaces of the light guiding device except for the light emitting surface,
wherein the light diffusing member is fixed on the enclosing member.

4. An image sensor apparatus, comprising:
a lighting unit comprising:
a light source generating light;
a light guiding device having a light emitting surface and configured to guide the light generated by the light source and to allow the light to come out through the light emitting surface towards a document to be read; and
a light diffusing member configured to cover the light emitting surface of the light guiding device and to diffuse the light coming out through the light emitting surface towards the document;
an image sensor configured to generate an electrical output in response to an amount of incident light received;
an image focusing member configured to receive and gather the light reflected from the document; and
a frame configured to support and form the lighting unit, the image sensor, and the image focusing member into a single construction.

5. The image sensor apparatus of claim 4, wherein the image focusing member includes a Cellhock lens, the lighting unit is arranged at a position next to the Cellhock lens, and the light diffusing member of the lighting unit is positioned by being arranged at a position in contact with the Cellhock lens.

6. The image sensor apparatus of claim 4, wherein the image sensor includes one of a photoelectric transducer and a charge-coupled device.

7. An image reading apparatus, comprising:
a contact glass configured to form a place on which a document to be read is placed; and
an image sensor disposed opposite to the document to be read relative to the contact glass and configured to read image information of the document, the image sensor comprising:
a light source generating light;
a light guiding device having a light emitting surface and configured to guide the light generated by the light source and to allow the light to come out through the light emitting surface towards a document to be read; and
a light diffusing member configured to cover the light emitting surface of the light guiding device and to diffuse the light coming out through the light emitting surface towards the document.

8. An image forming apparatus, comprising:
a contact glass configured to form a place on which a document to be read is placed; and
an image sensor disposed opposite to the document to be read relative to the contact glass and configured to read image information of the document, the image sensor comprising:
a light source generating light;
a light guiding device having a light emitting surface and configured to guide the light generated by the light source and to allow the light to come out through the light emitting surface towards a document to be read; and
a light diffusing member configured to cover the light emitting surface of the light guiding device and to diffuse the light coming out through the light emitting surface towards the document;
an image forming mechanism configured to form an image in accordance with the image information of the document read by the image sensor.

9. An image lighting apparatus, comprising:
generating means for generating light;
deforming means for deforming the light from the generating means into a strip form having a width covering a width of a document to be read;
guiding means for guiding the light towards the document to be read; and
adjusting means for adjusting an amount of the light in the strip form before reaching the document.

10. The image lighting apparatus of claim 9, wherein the adjusting means includes a light diffuser configured to diffuse the light advancing towards the document.

11. An image lighting method, comprising the steps of:
generating light;
deforming the light from the generating means into a strip form having a width covering a width of a document to be read;
guiding the light towards the document to be read; and
adjusting an amount of the light in the strip form before reaching the document.

12. The method of claim 11, wherein the adjusting step adjusts the amount of the light in the strip form before reaching the document by using a light diffuser configured to diffuse the light advancing towards the document.
